(19) United States
(12) Patent Application Publication
(10) Pub. No.: US 2024/0295016 A1
(43) Pub. Date: Sep. 5, 2024

(54) AUSTENITIC STAINLESS STEEL POWDER AND METHOD FOR PRODUCING SAME

(71) Applicant: COMPAGNIE GENERALE DES ETABLISSEMENTS MICHELIN, Clermont-Ferrand (FR)

(72) Inventors: STEPHANIE VERLEENE, Clermont-Ferrand (FR); PAULINE CHANIN LAMBERT, SAINT-ETIENNE (FR); CHRISTOPHE DESRAYAUD, SAINT-ETIENNE (FR); CLAUDE VARILLON, SAINT-ETIENNE (FR)

(21) Appl. No.: 18/571,957

(22) PCT Filed: Jun. 29, 2022
(86) PCT No.: PCT/FR2022/051301

§ 371 Date: Dec. 19, 2023

(30) Foreign Application Priority Data
Jun. 30, 2021 (FR) FR2107020

(51) Int. Cl. C22C 38/58; B22F 9/08; B22F 10/28; B33Y 10/00; B33Y 70/00; B33Y 80/00; C22C 38/00

(52) U.S. Cl. CPC C22C 38/58; B22F 9/08; B22F 10/28; C22C 38/001; B33Y 10/00; B33Y 70/00; B33Y 80/00

(57) ABSTRACT

The invention relates to a metal powder consisting of an austenitic stainless steel, to a metal part manufactured from such a powder and to the processes for producing them.

### TECHNICAL FIELD OF THE INVENTION

The invention relates to a metal powder consisting of an austenitic stainless steel, to a metal part manufactured from such a powder and to the processes for producing them.

### PRIOR ART

Steel powders can be used for the manufacture of metal parts by additive manufacturing. An additive manufacturing process makes it possible to produce a powder-based part by sintering or by melting grains of said powder using an energy beam. An “energy beam” is understood to mean electromagnetic radiation (for example a laser beam) or a beam of particles (for example a beam of electrons).

A particularly advantageous application of the additive manufacturing processes relates to the manufacture of lining elements, such as vanes, of a segmented-type curing or vulcanizing mould for vehicle tyres.

This type of mould mainly comprises two shells each providing the moulding of one of the lateral sidewalls of the tyre and a plurality of segments providing the moulding of the tread of said tyre which are radially movable between an open position and a closed position of the mould. The shells and the segments define an interior space intended to be brought into contact with the nonvulcanized preform of the tyre. In order to form the patterns of the tread, vanes are attached to the segments of the mould and jut out into this interior space. For more details on a mould comprising such vanes, reference may be made, for example, to the documents EP 1 758 743 and US 2002/0139164.

The value of the manufacture by selective melting of superimposed layers of powder, more commonly known as powder bed fusion, lies mainly in the fact that this technique is well suited to the manufacture of elements of small dimensions and of complex shapes, such as mould lining vanes, which are difficult to manufacture with other processes.

When the selective melting is carried out by a laser beam, this is referred to as sintering, when the melting of the powder grains is partial, or as laser melting. The laser melting technique consists in manufacturing the vane layer after layer, the layers of powder, which are consolidated and melted on top of one another by the laser beam, being stacked along a stacking direction. The term “powder” is understood to mean a powder or a mixture of powders which are mainly metallic but which can also be mineral, for example ceramic.

The first layer is deposited and then melted directly on the manufacturing plate. The other layers are then formed successively so as to obtain a stack starting from the first layer.

Generally, the manufacture of a small-sized element, such as a lining vane, is carried out horizontally over the manufacturing plate so that its length is substantially parallel to the manufacturing plate. It is then referred to as horizontal-type manufacturing. This makes it possible to avoid having too high a vane height and to thus reduce the manufacturing time. Such elements must exhibit good properties of breaking strength and/or of fatigue strength in order to ensure the longevity of their use.

The steel powders typically used in additive manufacturing processes are austenitic stainless steel powders. The austenitic phase is sought in order to avoid phase transformations during additive manufacturing, during which the change from the melting temperature to ambient temperature is very rapid and can result in deformations of the manufactured part.

Stainless steels are corrosion-resistant steels which contain at least 10.5% of chromium (if not, the steel is not a stainless steel). The chromium reacts with the oxygen of the air so as to form, at the surface of the steel, a passivating layer of chromium-rich oxide which gives stainless steels their corrosion resistance.

Stainless steels conventionally used in additive manufacturing processes are the steels 316 and 304, the composition ranges of which are defined by the AISI (acronym for “American Iron and Steel Institute”).

However, a disadvantage of stainless steels is that, in order to achieve a mechanical strength and a corrosion resistance compatible with the desired applications, it is generally necessary to carry out one or more thermomechanical treatments on the steel after having formed the part. This is in particular the case for austenitic stainless steels.

For example, a hyperquenching treatment can be carried out, which consists in keeping the austenitic stainless steel at a temperature of between 1000° C. and 1150° C. and in then cooling it rapidly. The precipitation of chromium carbides or carbonitrides, which can cause sensitivity to intergranular corrosion, is thus avoided. A homogenization treatment of a duration which can be greater than 24 h and at a temperature of between 1150° C. and 1200° C. can also be carried out in order to improve the properties of the austenitic steel by limiting the development of a ferritic phase.

The thermomechanical treatments described above exhibit several disadvantages. They are energy-consuming, complex to implement, in order to ensure reproducibility of the result obtained, and several of them must in some cases be applied consecutively in order to achieve the desired level of corrosion resistance or the desired level of mechanical strength. In addition, when applied to thin metal objects, such as lining vanes, which typically exhibit a thickness of between 0.2 mm and 0.4 mm, a risk exists of modifying their geometry during the heat treatment.

Another approach might be to increase the content of carbon and/or of cobalt. However, the increase in the content of carbon can result in cracking problems due to lack of weldability of the grade, while one aim is to minimize the use of cobalt, which presents health risks.

There thus exists a need for an austenitic stainless steel powder exhibiting, after melting, casting, atomization and manufacture of a part, good mechanical performance qualities and corrosion resistance, in particular without a thermomechanical treatment as described above being essential.

### Austenitic Steel Metal Powder

Unless otherwise indicated, all the percentages indicated in the present description are percentages by weight.

The invention provides a metal powder consisting of an austenitic stainless steel comprising, as percentages by weight:
C: 0.02% to 0.10%
Cr: 19.0% to 26.0%
N: 0.4% to 0.8%
Mn: 1.3% to 2.5%
Ni: 5.0% to 11.0%
Other entities: <0.05%
Fe: remainder to 100% of the weight of the steel.

Preferably, the metal powder according to the invention consists of an austenitic stainless steel comprising a content by weight of carbon of between 0.025% and 0.035%.

Preferably, the metal powder according to the invention consists of an austenitic stainless steel comprising a content by weight of nitrogen of between 0.5% and 0.7%.

Preferably, the metal powder according to the invention consists of an austenitic stainless steel comprising a content by weight of manganese of between 1.9% and 2.1%.

Preferably, the metal powder according to the invention consists of an austenitic stainless steel comprising a content by weight of nickel of between 8% and 10.5%.

Preferably, the metal powder according to the invention consists of an austenitic stainless steel in which the content of at least one of the elements cobalt, silicon, phosphorus and oxygen is less than 0.01%.

Preferably, the metal powder according to the invention consists of an austenitic stainless steel comprising, as percentages by weight, the following chemical elements:
C: 0.024% to 0.032%
Cr: 19.3% to 25.2%
N: 0.41% to 0.68%
Mn: 1.3% to 2.1%
Ni: 5% to 10.5%
Other entities: <0.05%,
Fe: remainder to 100% of the weight of the steel.

Preferably, the metal powder according to the invention consists of an austenitic stainless steel comprising less than 5%, preferably less than 1%, preferably less than 0.5%, of ferritic phase, as percentages by weight based on the weight of the steel.

Preferably, the metal powder according to the invention consists of an austenitic stainless steel comprising an austenitic phase hardened by at least a portion of the chromium atoms and/or of the nitrogen atoms.

Preferably, the metal powder according to the invention consists of an austenitic stainless steel in which more than 0.5%, indeed even more than 0.7%, of the nitrogen atoms are distributed in the interstitial position in the austenitic stainless steel, the percentages being expressed by weight based on the weight of the steel.

Preferably, the metal powder according to the invention consists of an austenitic stainless steel in which the content of chromium nitride, measured by X-ray diffraction, is less than 0.5% by weight.

The invention also relates to a metal part based on a metal powder according to the invention.

Preferably, the metal part according to the invention exhibits at least one, preferably at least two, more preferably the three following properties:
a yield point Re_{0.2} of greater than or equal to 600 MPa,
a breaking stress o_{b} of greater than or equal to 800 MPa, and
a deformation at break A_{b} of greater than 8%.

Preferably, the metal part according to the invention is a lining element, preferentially a vane of a mould for the curing of a rubber article.

The invention also relates to a process for the manufacture of a metal powder according to the invention comprising the following successive stages:
a. melting a feedstock in a non-oxidizing atmosphere formed of a nitrogen-containing gas until a molten material is obtained;
b. atomization of the molten material.

Preferably, in the process for the manufacture of a metal powder according to the invention, the nitrogen partial pressure of the nitrogen containing gas is of between 1 bar and 3 bar.

Preferably, in the process for the manufacture of a metal powder according to the invention, the nitrogen-containing gas comprises at most 10 000 ppm of molecular oxygen, preferably at most 9000 ppm of molecular oxygen and in a preferred way at most 8000 ppm of molecular oxygen.

Preferably, in the process for the manufacture of a metal powder according to the invention, the nitrogen-containing gas comprises more than 80% by volume, preferably more than 90% by volume, preferably more than 99% by volume, of nitrogen, in a preferred way consists of nitrogen.

The invention also relates to a process for the manufacture of a metal part by complete or partial melting of powder using at least one energy beam comprising at least the following successive stages:
i depositing at least one layer of metal powder according to the invention or resulting from the manufacturing process according to the invention on a working surface using a layering device comprising means for distribution of the powder which are movable with respect to said surface, and
ii melting, at least in part, said deposited layer using the energy beam;
iii. repeating stages i) and ii) to form the part by stacking of melted layers.

The layering device comprises means for distribution of the powder which are movable with respect to the working surface. These means can, for example, be movable in translation or in rotation.

Preferably, the process for the manufacture of a metal part according to the invention comprises a stage of finishing the part, preferably chosen from shaking-out, spruing, deburring, grinding, shot peening, sandblasting, brushing and polishing.

Preferably, the process for the manufacture of a metal part according to the invention comprises a stage of thermomechanical treatment of the part.

To the knowledge of the inventors, the austenitic stainless steel powder according to the invention has never been produced by conventional processes. As will become apparent subsequently, the process for the manufacture of the steel powder according to the invention, comprising the melting of the starting materials under a non-oxidizing atmosphere containing nitrogen under pressure, makes it possible to effectively control the nitrogen content of the steel and to limit the formation of carbon nitride precipitates, in particular in the intergranular position.

The steel powder according to the invention is an austenitic stainless steel (gamma phase) powder in which the content of chromium nitride, measured by X-ray diffraction, is less than 0.5% by weight.

Moreover, a metal part formed from stainless steel powder according to the invention exhibits good mechanical properties. It can exhibit at least one, preferably at least two, more preferably the three following properties:
a yield point Re_{0.2} of greater than or equal to 600 MPa, preferably of greater than 700 MPa,
a breaking stress o_{b} of greater than or equal to 800 MPa, preferably of greater than 900 MPa, and
a deformation at break A_{b} of greater than 8%, preferentially of greater than 10%, preferably of greater than 15%, very preferentially of greater than 25%.

Such mechanical performance qualities can be obtained without employing a thermomechanical treatment.

The yield point Re_{0.2} is measured at 0.2% plastic deformation by following Standards ISO 6892-1 and ASTM E8. The deformation at break A_{b}, measured according to the same standards, corresponds to the ratio of the elongation Δl to the initial length l₀ of the cylinder of the measurement test specimen. The elongation Δl corresponds to the difference between the length lᵣ of the cylinder of the test specimen when the force applied to the test specimen is maximum and the initial length l₀ of said cylinder. The deformation at break can be measured according to the abovementioned standard.

The content by weight of carbon can be between 0.02% and 0.045%, indeed even of between 0.025% and 0.035%. The content by weight of nitrogen can be of between 0.5% and 0.7%. The content by weight of manganese can be of between 1.9% and 2.1%. The content by weight of nickel can be of between 8% and 10.5%.

Unless otherwise indicated, the “other entities” are the entities not listed above, namely the entities other than Fe, C, Cr, N, Mn and Ni. In particular, the “other entities” can be impurities. The term “impurities” is understood to mean the inevitable constituents introduced unintentionally and necessarily with the starting materials or resulting from reactions with these constituents. Impurities are not necessary constituents but only tolerated constituents.

Thus, the other entities can contain cobalt, silicon, phosphorus or oxygen.

The cobalt content is preferably less than 0.01%. The silicon content is preferably less than 0.01%. The phosphorus content is preferably less than 0.01%. The oxygen content is preferably less than 0.01%.

According to a particular embodiment, the stainless steel of the powder according to the invention can comprise, as percentages by weight:
C: 0.024% to 0.032%
Cr: 19.3% to 25.2%
N: 0.41% to 0.68%
Mn: 1.3% to 2.1%
Ni: 5% to 10.5%
Other entities: <0.05%,
Fe: remainder to 100% of the weight of the steel.

The stainless steel is austenitic, that is to say that it comprises less than 5%, preferably less than 1%, preferably less than 0.5%, of ferritic phase, as percentages by weight based on the weight of the steel.

Preferably, the stainless steel comprises an austenitic phase hardened by at least a part of the chromium atoms and/or of the nitrogen atoms.

Preferably, more than 0.5%, indeed even more than 0.7%, of the nitrogen atoms are distributed in the interstitial position, the percentages being expressed by weight based on the weight of the steel. Such a distribution of the nitrogen atoms improves the ductility of the steel.

The stainless steel constituting the steel powder can comprise precipitates, in particular of chromium nitride essentially and potentially carbon nitrides.

### Process for the Manufacture of the Austenitic Steel Powder

The invention also relates to a process for the manufacture of a metal powder consisting of an austenitic stainless steel according to the invention.

Such a process comprises at least the following successive stages:
a) melting a feedstock in a non-oxidizing atmosphere formed of a nitrogen-containing gas until a molten material is obtained;
b) atomizing the molten material so as to obtain an austenitic steel powder according to the invention.

### Melting Stage a)

“Non-oxidizing” atmosphere is considered to mean an atmosphere substantially, indeed even completely, devoid of gaseous oxygen. Air does not constitute a non-oxidizing atmosphere. The non-oxidizing atmosphere can be reactive, and thus not neutral, because the nitrogen containing gas which forms it can react with elements of the feedstock to form nitride-containing precipitates.

The non-oxidizing atmosphere can be generated by injecting the nitrogen containing gas into the chamber. Flushing with the nitrogen containing gas can be carried out within the chamber.

Preferably, the nitrogen containing gas comprises more than 80% by volume, preferably more than 90% by volume, in a preferred way more than 99% by volume, of nitrogen. Preferably, it consists of nitrogen.

The nitrogen in the non-oxidizing atmosphere dissolves in the molten material and thus increases the final concentration in the material. Stage a) is carried out so as to obtain a content of nitrogen in the austenitic stainless steel metal powder ranging from 0.4% to 0.8% by weight. Thus, the nitrogen partial pressure of the nitrogen-containing gas preferably ranges from 1 to 3 bar, preferentially is greater than 1 bar, in a preferred way greater than 1.1 bar, indeed even greater than 1.2 bar, indeed even greater than 1.5 bar, indeed even substantially equal to 2 bar, stage a) having a duration sufficient to reach the targeted contents. For example, stage a) can last from 5 to 30 min, preferentially from 5 to 20 min.

Preferentially, the nitrogen partial pressure of the nitrogen-containing gas is less than or equal to 2 bar. This is because there exists a risk of nitriding when the nitrogen partial pressure of the nitrogen-containing gas is too high, in particular when the nitrogen pressure of the nitrogen-containing gas is greater than 3 bar, it being possible for this nitriding to cause damage to the walls of the melting furnace and pollution of the steels subsequently produced.

Preferably, the non-oxidizing atmosphere comprises a low content of oxygen. Thus, the nitrogen-containing gas preferably comprises at most 10 000 ppm of molecular oxygen, preferably at most 9000 ppm of molecular oxygen and in a preferred way at most 8000 ppm of molecular oxygen.

The feedstock used in stage a) consists of starting materials chosen so that the powder obtained on conclusion of the atomization stage is in accordance with the invention.

Thus, the feedstock consists of a mixture of starting materials making it possible to have the final composition desired for the steel powder. These starting materials are mainly ferrochrome, pure nickel, pure manganese and carbon.

The feedstock can be in solid form. It can be charged into the crucible at ambient temperature, less than 50° C.

The feedstock can be placed in an airtight chamber.

The feedstock can be contained in a crucible. Preferably, at the end of stage a), the crucible contains a bath comprising the molten material. Preferably, the molten material represents more than 95%, preferably more than 99%, preferably more than 99.9%, indeed even substantially 100%, of the weight of the bath.

Melting can be carried out by means of any type of furnace conventionally used in the industry, for example an induction furnace or an arc furnace.

Melting can be carried out until the bath of molten material is obtained at a temperature of between 1500° C. and 2000° C., preferably at a temperature of between 1500° C. and 1600° C.

### Atomization Stage b)

The molten material is subsequently atomized in a way known to a person skilled in the art, for example using a high-pressure gas jet through an atomization nozzle. The droplets produced solidify and form the powder.

Sieving is advantageously used in order to precisely target the desired particle size, which can be monitored by any means known to a person skilled in the art, such as optical or laser particle size measurement.

### Process for the Manufacture of a Metal Part

The invention also relates to a process for the manufacture of a metal part by complete or partial melting of powder using at least one energy beam by carrying out at least the following stages:
a) depositing at least one layer of metal powder according to the invention, or of a metal powder resulting from the process for the manufacture of austenitic steel powder according to the invention, on a working surface using a layering device comprising means for distribution of the powder which are movable with respect to said surface;
b) melting, at least in part, said deposited layer using the energy beam;
c) repeating stages a) and b) to form the part by stacking of melted layers.

During stage b) of the process for the manufacture of a metal part, at least a portion of the layer of metal powder deposited on the working surface is melted. Preferably, the powder grains constituting this melted layer portion are completely melted.

The process for the manufacture of a metal part can also, for example, comprise a stage d) of finishing the part, preferably chosen from shaking-out, spruing, deburring, grinding, shot peening, sandblasting, brushing and polishing. The term “finishing” is envisaged as meaning any operation carried out on the part once the casting stage is completed in order to make the finished part capable of immediate use.

The process for the manufacture of a metal part can also comprise a stage of thermomechanical treatment of the part. The thermomechanical treatment stage can be prior or subsequent to the finishing stage.

The thermomechanical treatment stage can comprise operations of forges, hot hammerings, sequenced with reheating operations with the thermal furnace, sandblastings, shot peenings, polishings, oilings. Heat treatments can also be applied to relieve the parts of stress or to improve the mechanical properties.

The metal part obtained by the manufacturing process of the invention exhibits good mechanical performance qualities and corrosion resistance, without a thermomechanical treatment as described above being essential.

Preferably, the metal part is a lining element, preferentially a vane of a mould for the curing of a rubber article.

A process for the manufacture from metal powders of lining vanes for moulds for the curing of rubber articles is known to a person skilled in the art and described, for example, in the document WO 2016/016136.

### EXAMPLES

The examples were produced in the following way. For each example, the starting materials were weighed so as to obtain the composition indicated in Table 1 below.

A feedstock formed of the starting materials is placed in a crucible. The crucible is introduced into an airtight chamber. Nitrogen is injected at an absolute pressure of 1 bar.

The chamber is heated to a temperature of between 1500° C. and 1600° C. by means of an induction furnace, until a bath of molten material is obtained, the latter being maintained for a period of time of 15 min.

The material is subsequently atomized so as to produce an austenitic steel powder.

The composition of the stainless steel, expressed as percentages by weight based on the weight of the steel, is shown in Table 1, for each example. The balance to 100% of the weight of the steel consists of iron. The composition was measured by inductively coupled plasma (ICP) spectrometry using a LECO spectrometer.

The particle size distribution of the powders (d10, d50, d90) is determined following the Standard ISO 13320-1 or ASTM B822.

Test specimens were subsequently constructed from the steel powders by additive manufacturing using a selective laser melting process (powder bed fusion). The process is carried out according to the parameters presented in Table 1.

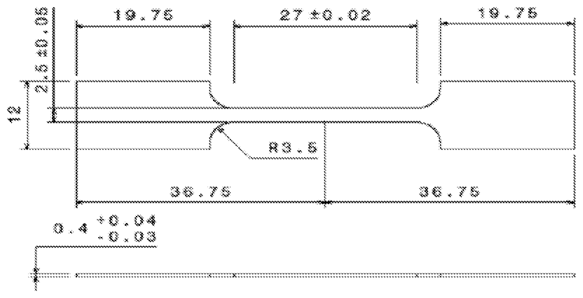

The test specimens manufactured are represented in FIG. 1. They exhibit a thickness of 0.4 mm and two widened ends in order to make it possible to fix them in a clamping jaw.

The yield point, breaking stress and deformation at break measurements are carried out according to Standards ISO) 6892-1 and ASTM E8.

TABLE 1

| | | | | | Comparative | |
|---|---|---|---|---|---|---|
| | Examples in accordance | | | | Steel | Steel |
| | 1 | 2 | 3 | 4 | 304L | 316L |
| Composition | Powder | Powder | Powder | Powder | Powder | Powder |
| % wt | | | | | | |
| C | 0.025 | 0.032 | 0.024 | 0.031 | 0.018 | 0.03 |
| Mn | 2 | 2 | 2 | 1.3 | 1.4 | 0.38 |
| Cr | 20.7 | 20.5 | 25.2 | 19.9 | 18.4 | 17.53 |
| N | 0.54 | 0.53 | 0.66 | 0.41 | 0.06 | 0 |
| Ni | 10.2 | 5.2 | 10.5 | 10.1 | 9.8 | 12.06 |
| Si | <0.05 | <0.05 | <0.05 | <0.05 | 0.6 | 0.86 |
| Mo | <0.05 | <0.05 | <0.05 | <0.05 | 0 | 2.16 |
| Fe | q.s. | q.s. | q.s. | q.s. | q.s. | q.s. |
| | for 100 | for 100 | for 100 | for 100 | for 100 | for 100 |
| Particle | d₁₀ = | d₁₀ = | d₁₀ = | d₁₀ = | d₁₀ = | d₁₀ = |
| size | 5.2 μm | 5.2 μm | 4.4 μm | 7.3 μm | 8 μm | 22.5 μm |
| distribution | d₅₀ = | d₅₀ = | d₅₀ = | d₅₀ = | d₅₀ = | d₅₀ = |
| | 14.0 μm | 12.7 μm | 13.7 μm | 14.2 μm | 25 μm | 39.02 μm |
| | d₉₀ = | d₉₀ = | d₉₀ = | d₉₀ = | d₉₀ = | d₉₀ = |
| | 28.2 μm | 24.7 μm | 28.2 μm | 25.8 μm | 52 μm | 56.04 μm |

Additive manufacturing conditions

| | | | | | | |
|---|---|---|---|---|---|---|
| Speed (mm/s) | 1000 | 1000 | 1000 | 1000 | 800 | 600 |
| Power (W) | 117 | 147 | 153 | 147 | 200 | 150 |
| Hatching | 50 | 50 | 50 | 50 | 85 | 80 |
| distance (μm) | | | | | | |
| Layer thickness | 40 | 40 | 40 | 40 | 50 | 40 |
| (μm) | | | | | | |

Measurements on manufactured metal parts

| | | | | | | |
|---|---|---|---|---|---|---|
| Yield point | 792 | 787 | 755 | 707 | 490 | 489 |
| Re_{0.2} (MPa) | | | | | | |
| Breaking | 956 | 921 | 889 | 820 | 680 | 665 |
| stress Rₘ | | | | | | |
| (MPa) | | | | | | |
| Deformation | 18 | 10.2 | 8.6 | 8.2 | 41.8 | 29.3 |
| at break A_{b} | | | | | | |
| (%) | | | | | | |

The additive manufacturing conditions had to be slightly adjusted for the 304L, and 316L steels due to the larger particle size of the powders.

It is observed that the test specimens manufactured from a powder in accordance with the invention exhibit more advantageous mechanical properties than the test specimens formed from 304L or 316L steel powder.

1.-15. (canceled)

16. A metal powder consisting of an austenitic stainless steel comprising, as percentages by weight, the following chemical elements:
C, 0.02% to 0.10%;
Cr, 19.0% to 26.0%;
N, 0.4% to 0.8%;
Mn, 1.3% to 2.5%;
Ni, 5.0% to 11.0%;
other, <0.05%; and
Fe, a remainder to 100% of the weight of the austenitic stainless steel.

17. The metal powder according to claim 16, wherein the austenitic stainless steel comprises a content by weight of carbon of between 0.025% and 0.035%.

18. The metal powder according to claim 16, wherein the austenitic stainless steel comprises a content by weight of nitrogen of between 0.5% and 0.7%.

19. The metal powder according to claim 16, wherein the austenitic stainless steel comprises a content by weight of manganese of between 1.9% and 2.1%.

20. The metal powder according to claim 16, wherein the austenitic stainless steel comprises a content by weight of nickel of between 8% and 10.5%.

21. The metal powder according to claim 16, wherein the content of at least one of the elements cobalt, silicon, phosphorus and oxygen is less than 0.01%.

22. The metal powder according to claim 16, wherein the austenitic stainless steel comprises, as percentages by weight, the following chemical elements:
C, 0.024% to 0.032%;
Cr, 19.3% to 25.2%;
N, 0.41% to 0.68%;
Mn, 1.3% to 2.1%;
Ni, 5% to 10.5%;
other, <0.05%; and
Fe, the remainder to 100% of the weight of the austenitic stainless steel.

23. The metal powder according to claim 16, wherein the austenitic stainless steel comprises less than 5% of Fe as a percentage by weight based on the weight of the austenitic stainless steel.

24. The metal powder according to claim 16, wherein a content of chromium nitride, measured by X-ray diffraction, is less than 0.5% by weight.

25. A metal part based on the metal powder according to claim 16.

26. The metal part according to claim 25, wherein the metal part exhibits at least one of the following properties:
a yield point Re_{0.2} of greater than or equal to 600 MPa;
a breaking stress o_{b} of greater than or equal to 800 MPa; and
a deformation at break A_{b} of greater than 8%.

27. The metal part according to claim 25, wherein the metal part is a lining element.

28. A process for the manufacture of the metal powder according to claim 16, the method comprising the following successive steps:
(a) melting a feedstock in a non-oxidizing atmosphere formed of a nitrogen-containing gas until a molten material is obtained; and
(b) atomizing the molten material.

29. The process according to claim 28, wherein a nitrogen partial pressure of the nitrogen-containing gas is of between 1 bar and 3 bar.

30. A process for the manufacture of a metal part by complete or partial melting of austenitic stainless steel powder using at least one energy beam, the method comprising the following successive steps:
(i) depositing at least one layer of the metal powder according to claim 16 on a working surface using a layering device comprising means for distribution of the metal powder which are movable with respect to the surface;
(ii) melting, at least in part, the deposited layer using the energy beam; and
(iii) repeating steps (i) and (ii) to form the metal part by stacking melted layers.

31. A process for the manufacture of a metal part by complete or partial melting of austenitic stainless steel powder using at least one energy beam, the method comprising the following successive steps:
(i) depositing at least one layer of the metal powder made according to the process of claim 28 on a working surface using a layering device comprising means for distribution of the metal powder which are movable with respect to the surface;
(ii) melting, at least in part, the deposited layer using the energy beam; and
(iii) repeating steps (i) and (ii) to form the metal part by stacking melted layers.
